(19) United States
(12) Patent Application Publication
(10) Pub. No.: US 2015/0109779 A1
(43) Pub. Date: Apr. 23, 2015

(54) Dual Plasma Luminaire for Indoor Horticulture

(71) Applicant: Thomas C. Dimitriadis, Gardnerville, NV (US)

(72) Inventor: Thomas C. Dimitriadis, Gardnerville, NV (US)

(21) Appl. No.: 14/515,978

(22) Filed: Oct. 16, 2014

Related U.S. Application Data
(60) Provisional application No. 61/892,690, filed on Oct. 18, 2013.

(51) Int. Cl. F21V 7/00

(52) U.S. Cl. CPC F21V 7/0066
USPC 362/235

(57) ABSTRACT

An illumination apparatus comprises a compound reflector panel for directing light energy from at least two solid state, point source light emitter into a combined emission pattern having substantially uniform spatial and spectral illumination at a predetermined target area. The first and second light emitters, mounted in respective first and second defined portions of the compound reflector panel, effectively provide point sources, each having a defined spectral characteristic. The spectral characteristics may be selected to provide appropriate bandwidth and intensity of illumination for indoor horticultural applications.

### CROSS REFERENCE TO RELATED APPLICATIONS

The present U.S. patent application claims priority to U.S. Provisional Patent Application Ser. No. 61/892,690 filed Oct. 18, 2013 and entitled “PLASMA LUMINAIRE FOR INDOOOR HORTICULTURE.”

### BACKGROUND OF THE INVENTION

1. Field of the Invention

The present invention generally relates to lighting fixtures and more particularly to high-efficiency illumination apparatus for producing particular spatial and spectral light emission patterns at a specified target distance.

2. Background of the Invention and Description of the Prior Art

Lighting fixtures have been designed to satisfy numerous and varied lighting requirements. Light emitting sources of many types are available, and a great variety of fixture designs have been produced to utilize these light emitting sources as efficiently as possible. In one field of lighting design, for example, fixtures are designed to provide spectral illumination that enhances the growth of horticultural products. Conventional fixtures, often called “grow lights,” designed for indoor horticulture often use high pressure sodium (HPS) lamps which are moderately efficient, gas-discharge elements but are relatively large for the amount of light output (Lumens) produced. Metal halide bulbs are also commonly used, and while they are characterized by a broad emission spectrum, they likewise are relatively large for the amount of light output produced. Lighting fixtures designed for use with HPS or metal halide light sources, because of their relatively large size tend to be bulky, which limits their adaptability to applications requiring compact solutions to lighting needs.

Fluorescent bulbs have long been used in lighting fixtures for indoor horticulture because of their relative efficiency as compared with incandescent or other types of light sources, and because bulbs are readily available that can be coated with special phosphors to provide the desired wavelengths of light. However, fluorescent bulbs are bulky, fragile, may require heavy ballasts, and emit light that is largely diffuse, which makes them less than acceptable for luminaries requiring a well-controlled light field.

One important measure of the performance of a lighting fixture is called Luminaire Efficacy, usually expressed as a figure of merit: LER, which stands for luminaire efficacy rating. It is calculated by dividing the product of luminaire efficiency, total lamp lumens, and ballast factor (if a ballast is used) by the input electrical power in watts used by the fixture. Due to the large size of HPS and metal halide lamps, which tends to limit the efficiency of the luminaire in utilizing all of the emitted light from the light source, the LER figures typically fall short of a new NEMA (National Electrical Manufacturer's Association) standard that is scheduled to take effect in the year 2015. Thus, to meet this standard, and solve the problems of meeting efficiency requirements, particularly in the field of indoor horticultural illumination, where relatively precise control of the light field produced at the location of the plants is advantageous, an alternative fixture design will be needed.

### SUMMARY OF THE INVENTION

An illumination apparatus comprises a compound reflector panel for directing light energy from at least two solid state, point source light emitter into a combined emission pattern having substantially uniform spatial and spectral illumination in the light field produced at a predetermined target area. The first and second light emitters, mounted in respective first and second defined portions of the compound reflector panel, effectively provide point sources, each having a defined spectral characteristic. The spectral characteristics may be selected to provide appropriate bandwidth and intensity of illumination for indoor horticultural applications.

In one embodiment an illumination apparatus is provided comprising a compound reflector panel formed of first and second reflecting portions for directing light energy from at least two spaced-apart, point source light emitters into a composite light emission pattern having substantially uniform spatial and spectral illumination of a predetermined target area; and first and second solid state plasma light emitters, having dissimilar spectral characteristics and mounted in spaced-apart relationship in the respective first and second reflecting portions of the compound reflector panel.

Aspects of the above embodiment include an array of flat, intersecting surfaces, joined together along a common boundary and disposed around each light source, the panels arranged to reflect emission from each light emitter into a merged pattern of illumination at the predetermined target area, wherein the common boundary defines the apex of a substantially V-shaped, downward-pointing ridge disposed midway between the first and second light emitters and aligned at a right angle to a centerline between the first and second light emitting sources. In another aspect of the above embodiment, the first and second solid state plasma light emitters comprise emitters approximating point sources of light and having broadband emission characteristics within at least a portion of the visible spectrum.

In another embodiment an illumination apparatus is provided comprising a compound reflector panel, formed of first and second defined reflecting surfaces and joined along a common boundary, for directing light energy from at least two spaced-apart, point source light emitters into a combined emission pattern having substantially uniform spatial and spectral illumination at a predetermined target area; and first and second solid state light emitting diodes (LEDs), each approximating point sources of light having dissimilar emission characteristics within a substantial portion of the visible spectrum and mounted in the respective first and second defined reflecting surfaces of the compound reflector panel.

Aspects of the above embodiment include an array of flat, intersecting surfaces, joined together along a common boundary and disposed around each light source, the panels arranged to reflect emission from each light emitter into a merged pattern of illumination at the predetermined target area, wherein the common boundary defines the apex of a substantially V-shaped, downward-pointing ridge disposed midway between the first and second light emitters and aligned at a right angle to a centerline between the first and second light emitting sources. In another aspect of the above embodiment, the first and second solid state light emitting diodes comprise emitters approximating point sources of light and having broadband emission characteristics within at least a portion of the visible spectrum.

In another embodiment an illumination apparatus for indoor horticulture is provided, comprising a compound reflector panel having first and second reflecting portions for directing light energy respectively from a first and a second spaced-apart, point source light emitter; the compound reflector panel formed as an array of reflecting surfaces disposed around each first and second light emitter, the surfaces formed by respective frustrums of first and second right, rectangular or triangular pyramid-shaped shells partially merged and joined together along a common boundary which defines the apex of a substantially V-shaped, downward-pointing ridge disposed midway between the first and second light emitters, the ridge aligned substantially at a right angle to a centerline between the first and second light emitters; and first and second solid state plasma light emitters, having dissimilar spectral characteristics and mounted in spaced-apart relationship in the respective first and second reflecting portions of the compound reflector panel; wherein the compound reflector panel provides a merged pattern of illumination at a predetermined target area with substantially uniform spatial and spectral illumination thereof.

### BRIEF DESCRIPTION OF THE DRAWINGS

FIG. 1 illustrates a view of the reflecting surface of the dual plasma luminaire according to the present invention;

FIG. 2 illustrates components of one embodiment of the reflecting surface for the embodiment of FIG. 1;

FIG. 3 illustrates a side view drawing of the main reflector panel for the dual plasma luminaire of FIGS. 1 and 2;

FIG. 4 illustrates an end view of the main reflector panel of FIG. 3; and

FIG. 5 illustrates a side view of a luminaire according to the present invention with its side panel removed to show internal features.

### DETAILED DESCRIPTION OF THE INVENTION

A luminaire is a device for directing light emitted from a light source toward the working area to be illuminated. A luminaire may also include features to diffuse the light, to reduce glare, to shield person's eyes from the direct rays of the light, which may be quite intense, etc. In an advance in the state of the art a more efficient and compact luminaire having an optimum spectral light output for use in indoor horticulture applications an illumination apparatus is disclosed for solving the aforementioned problems discussed in the Background of the Invention. The solution is provided by combining at least two independent, high-efficiency light sources or emitters having point-source emission characteristics and differing spectral bandwidths such that the emission from each light emitter is merged into a single pattern of illumination. This combined pattern can provide a compound spectral output that is broader, i.e., provides a wider bandwidth than a single light emitting source, that has a color temperature selected for a particular application, or that has an intensity of illumination at a specified target distance or area that is greater than or more uniformly dispersed than that produced by a single light emitting source.

In other words, the illumination provided by the invention may be a composite of first and second dissimilar (or similar) bandwidths of visible light emitted by individual point sources and dispersed by a compound, specially configured reflector to provide illumination in horticultural applications that is uniform in spectral bandwidth, color temperature, and intensity of lighting. Thus, in embodiments of the invention, the spectral power distribution (light output) may be tuned to a particular bandwidth, or modified to cover a wider range of emission frequencies or to cover a target area with a greater or better regulated intensity. The modification of bandwidth may, for example, be incorporated into the light emitting structure itself or controlled by filtering the emitted light. The invention, for use in a luminaire, comprises a compound reflector surface that includes at least first and second reflecting sections, each one surrounding a light emitter and configured to direct the light emission from each emitter toward the target area. The reflecting structure may be further configured such that the light emission patterns are combined into a single pattern to produce the desired illumination pattern at the target area.

The compound reflector panel may be formed in a variety of ways, that is by merging several individual reflecting surfaces side-by-side into a single reflecting surface capable of dispersing the emitted light into a particular pattern. In general, the optimum pattern is one in which the light from, for example, two light emitters, preferably having point source characteristics that are properly spaced with respect to each other, is directed (by the system of specially configured reflectors) to provide a desired illumination pattern. In an illustrated embodiment of the invention to be described, the combination of direct and reflected light provides an illumination pattern that is approximately 24 inches square at a distance of 15 inches below the reflector. This defines the pattern at the nearest recommended distance for this size luminaire. At a distance of 36 inches the light pattern or beam may be approximately 4 feet×4 feet square in a typical indoor grow room. In some applications the luminaire using the present invention may be used at distances up to six to eight feet above the region to be illuminated for supplemental lighting in green houses. Thus, it is contemplated that the configuration, dimensions, and light emitter specifications of the luminaire, including the shape and dimensions of the compound reflector, and the spacing and illumination outputs of the light emitters described herein may be scaled to the particular application.

In one embodiment of the invention an individual reflector may be formed by an array of flat surfaces, for example in the manner of a right rectangular or triangular pyramid with a portion of the apex removed along an upper plane substantially parallel to the base of the figure. As is understood in the geometric arts, removal of a portion of such a figure along an (upper) plane parallel to the base of the figure forms a frustum. The inside surfaces of the three-dimensional figure thus formed extend away (and, in the embodiments of the invention as depicted herein, downward) from the upper plane of the figure. The light emitting source may advantageously be located in the center of the upper plane. When two such surfaces are brought toward each other and merged, the merged surfaces of each reflector may intersect along a predetermined common or mutual boundary between the light emitting sources.

Upon merging two such reflectors laterally toward each other their proximate surfaces will intersect along a predetermined central boundary. As thus merged or joined, the intersection of the adjoining surfaces may be configured to provide a substantially V-shaped reflecting element disposed centrally between the first and second light emitters, each mounted in a middle portion of the respective upper planes (or apex) of the two reflectors. This V-shaped reflecting element, which is disposed generally at a right angle with respect to a centerline between the two light emitters, may be adjusted in its depth or angles to tailor the direction of a portion of the reflected light or to provide some shielding effect, depending on the desired illumination objective.

Regarding the construction of the compound reflector, the material used for the reflecting surfaces should be highly reflective to avoid loss of efficiency. It is preferable that the intersection of the various reflecting surfaces be seamless to avoid reflective losses. A suitable material for the reflector in relatively small luminaries is bright aluminum sheet having a thickness of 0.020 inch. In larger luminaries a heavier gauge sheet material may be required. A suitable finish for the bright aluminum sheet used in the illustrated embodiment is known as a textured or “stucco” surfaced bright aluminum. The foregoing embodiments of the compound reflector are intended to be illustrative of the concepts of the present invention and not limiting.

The preferred light emitting sources (or, light emitters) used in the embodiments described herein are solid state plasma elements driven by an RF power amplifier that provide a nominal point source of broad spectrum light energy in the visible range. Such light emitters are advantageous because of the small physical size of the light emitting element itself, which thus approximate quite well the characteristics of point source emitters. Unlike high pressure sodium or metal halide lamps, which have large and relatively bulky light emitting elements, the light emitting element or bulb of a solid state plasma lamp is small and nominally spherical, to approximate a point source operable into 2π steradians (i.e., a hemisphere) or lesser spherical angles when installed in a reflector system. This characteristic permits the design of highly efficient reflectors for lighting fixtures, providing luminaries with better tailoring of the light spectrum and intensity to particular applications such as indoor horticulture. While many variations are possible in the selection of the light emitting sources, in one production unit light sources having outputs of 3000° K works well for plant growth.

The importance of a point source is that reflectors are easier to design, and often less of a compromise because the light source can be positioned well-back from the outer edges of the reflecting surfaces when designing a reflector for uniform illumination of the target plant array. Such positioning facilitates better control of the light emission, thereby allowing more efficient luminaries to be constructed. One reason for this is that it is easier to combine point sources when the light output of one source is insufficient for the task. For example, when it is desired to provide more spatially uniform and predictable illumination from a luminaire having relatively compact dimensions such as the indoor fixtures described herein, it may be easier to combine two dissimilar or similar spectral outputs using two small, point source light emitters.

Another reason is that, compared with simply installing two conventional fixtures side-by-side, a compound reflector design that utilizes two light sources will usually be smaller, lighter in weight, and have lower costs than two separate fixtures. Moreover, merging the light outputs of two dissimilar (or similar) light sources having specifically defined emission outputs in a single, compound, reflector generally provides a more efficient luminaire and one having higher performance—e.g., a higher figure of merit (LER) for a given space requirement, as well as a more uniform illumination of the working area. As mentioned previously, another advantage of using two light emitters is that each one can be selected for a specifically defined spectral output. Thus, the composite output of two light emitters, properly spaced relative to one another, increases the available light, and, if the two light sources have dissimilar bandwidths, may enable broader bandwidth to cover the entire visible spectrum with full output, or, alternatively, enable the opportunity to adjust the intensity and spectral balance of the overall light output. In some embodiments, additional control circuitry (not shown herein but which is well-known by persons skilled in the electronic arts) may be used to enhance the performance and operation of the luminaire that employs the combination of a compound reflector equipped with two highly efficient point sources of light having dissimilar (or similar) light emission bandwidths.

The light emission from a point source is theoretically omni-directional. When installed in a defined (usually central) portion, or the apex of the reflector, the radiation pattern is typically confined within a solid radiation angle between approximately 2π (wide angle˜hemispherical) and π (less wide of an angle) steradians, depending on the shape and configuration of the reflecting surfaces of the compound reflector. Generally, each light source is positioned in the center of its respective portion of the compound reflector as shown in the figures to be described.

There are several examples of solid state light sources having elements that are essentially point sources, mainly because their light emitting elements are relatively small. In current lighting technology, both solid state plasma light units and light emitting diodes (“LEDs”) are suitable for the present invention, because of their efficiency, small size, and ready availability. In the example to be described, the solid state plasma light units are preferred because of their well-characterized spectral outputs, high efficiency, and the intensity available from this type of emitter. However, as LEDs become economically practical in indoor lighting products, they may be used to the same advantages as the plasma light units, perhaps with even greater efficiency, when paired with the compound reflector panels described herein and perhaps suitable lens elements to control the light emission from the LED elements. LED light sources having similar illumination and power output characteristics to the solid state plasma lamps may be substituted for the plasma units in the present invention with similar results. One advantage of the LED light sources is their reduced heat output. Future technology may provide other light source elements that have the combination of characteristics described herein. These light sources, not yet available, may be utilized in the present reflector configurations with similar or even superior performance.

The accompanying drawings to be described hereinafter depict one embodiment of the present invention to illustrate the concepts employed in its design. These concepts are set forth in the claims appended to this description. Accordingly, the drawings are not intended to be limiting, and persons skilled in the art will recognize that a variety of luminaire configurations and reflector/light emitter combinations are possible using the principles illustrated herein and that there are many possible variations that fall within the scope of the present invention. Reference numbers appearing in more than one drawing refer to the same structural feature.

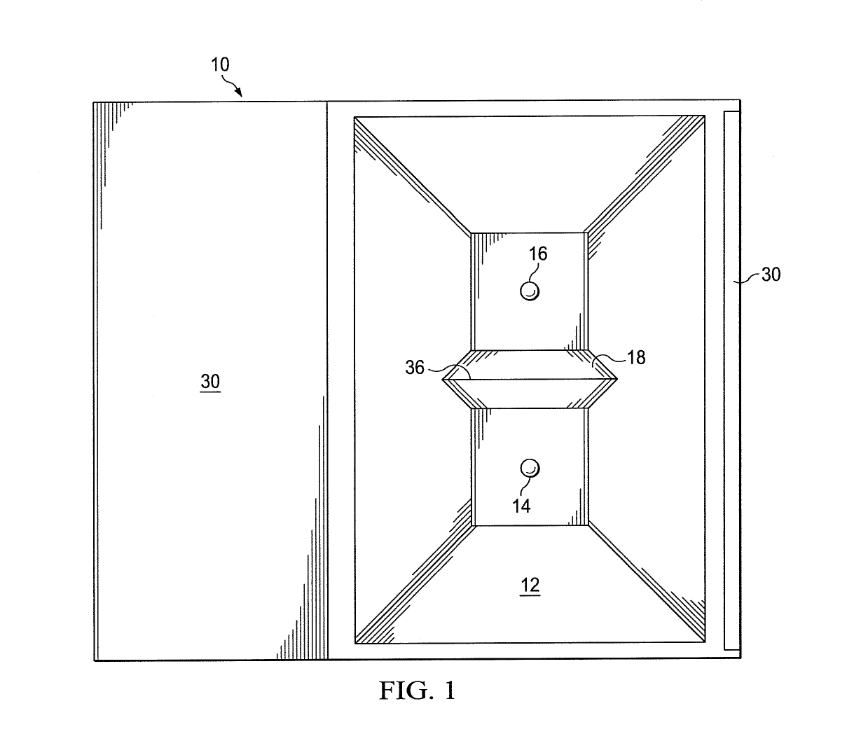

FIG. 1 illustrates a view of the reflecting surface of one example of a dual plasma luminaire 10 according to the present invention. The luminaire 10 in this example includes a reflector 12 formed of 0.020″ sheet aluminum having a bright, stucco textured finish that is 95% to 98% reflective. Alternative finishes may include “pebbletone 95% reflective” at 0.020″ or 0.030″ thick or “specular finish 98% reflective” at 0.020″ thick. One aluminum alloy that has been found suitable for the present invention is designated type 5052 because of its ease of workability and low cost.

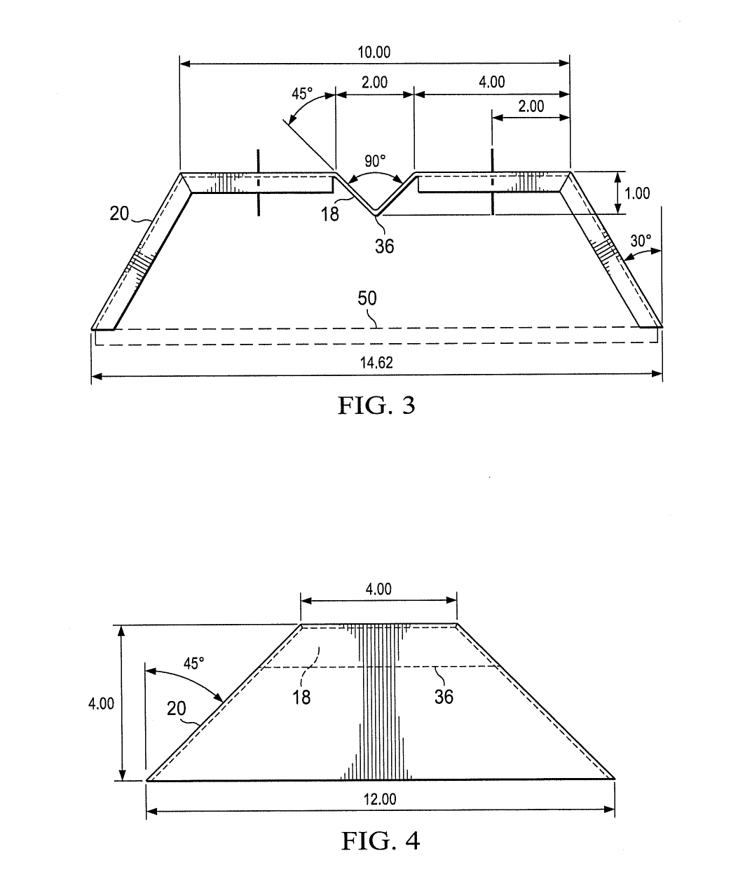

The basic form of the reflector combines the surfaces of two right rectangular pyramid forms along an intersecting boundary such that a substantially V-shaped ridge reflector 18 is formed mid-way between the positions of the two light emitters 14, 16. A rectangular center portion of the reflector 12 includes the first 14 and second 16 solid state plasma lamp assemblies spaced approximately six inches apart (in the illustrated examples), one on either side of a V-shaped, inverted ridge reflector 18 disposed across the width of the center portion of the reflector 12. The apex 36 of this V-shaped portion (at the bottom of the “V,” viewed in cross section) may form an angle of approximately 90 between the sides of the ‘V’ (See FIG. 3) and be disposed along the intersection of the adjoining portions of first and second reflector sections (the common or mutual boundary), one for each light emitter 14, 16. So configured, the ridge reflector 18 adds reflective surface area to the reflector 12 and disperses the reflected light to form a substantially uniform illumination pattern at the target distance. However, the ridge reflector 18 is not so pronounced as to distort the emission patterns of the two light emitters 14, 16 or form separate emission beams from the two light emitters. In practice, the V-shaped ridge defines a partial reflecting barrier to a proximate portion of the light rays emitted laterally from each first and second light emitter. Each side of the rectangular center portion of each portion of the reflector 12 is extended at an angle of approximately 120 degrees to 150 degrees relative to the center portion to disperse and reflect light from the lamps 14, 16 outward from the plane of the photo. The reflector 12 is supported in a housing or canopy 30 to form the luminaire 10.

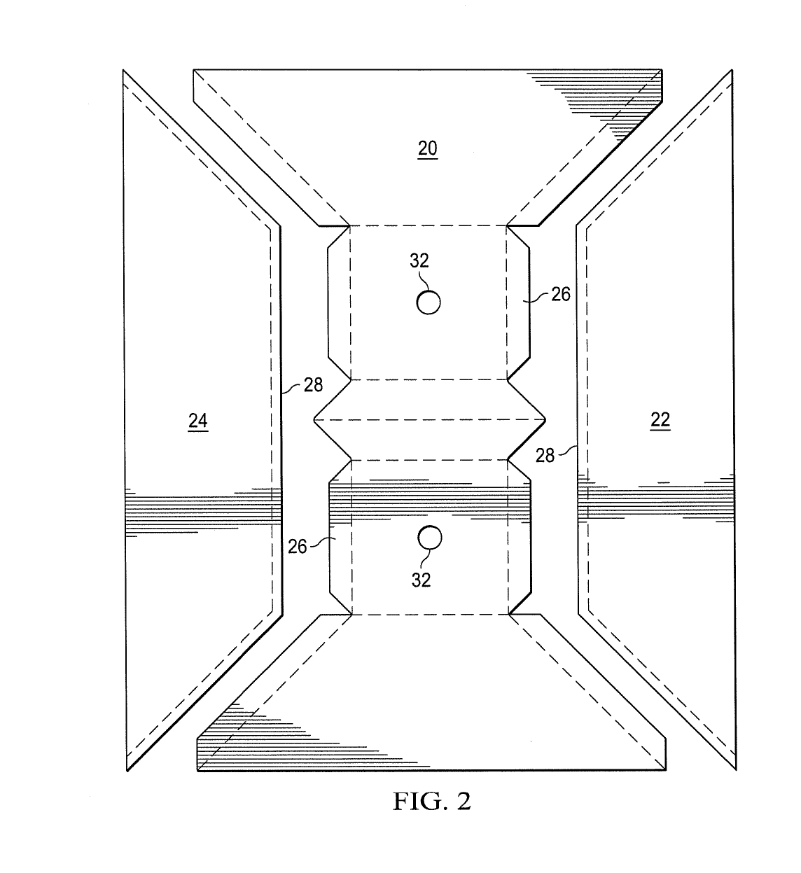

FIG. 2 illustrates components of one embodiment of the reflecting surfaces of the reflector 12 of the embodiment of FIG. 1 in blank form prior to assembly into a composite version of the reflector 12. A first blank 20 may be cut to the shape shown in the figure, along with second 22 and third 24 (side) blanks. All three blanks 20, 22, and 24 may be cut in a single stamping press, including any bends or other features required in the respective components. The first 20, second 22, and third 24 blanks may alternatively be cut and bent by hand or other manual operation. If the reflector is stamped as a single piece, a set of dies may be tooled to provide a finished part from the sheet metal stock. Dashed lines along the edges of the blanks represent the locations of spot welds or rivets if used and of the axes where material is bent to form a joint with an adjoining panel. The extensions 26 enable a relatively close-fitting joint to be made between the respective parts to minimize the escape of light. The first blank 20 may include extensions 26 formed in the manner of tabs to be riveted or spot welded to the corresponding edges 28 of the second 22 and third 24 blanks along the edges of the first blank 20. The riveting or spot welding operations may be performed after the first blank 20 is bent to the form shown in FIG. 3 to be described. As noted above, the reflector 12 may preferably be formed of 0.020″ sheet aluminum having a bright, stucco textured finish that is 95% to 98% reflective. Reflectivity and light weight are important considerations in the selection of material.

FIG. 3 illustrates a side view drawing of the first blank 20 (or main reflector panel 20) for the luminaire 10 of FIG. 1. The drawing is approximately to scale, depicting a formed first blank 20 having an overall length of approximately 15 inches (left-to-right in the figure) and an overall height of approximately 4 inches. These dimensions are not intended to be limiting; rather, they are provided to illustrate the proportions and approximate size of one embodiment of the invention. The angles as marked are representative and approximate. As oriented in the drawing, the “V” shaped ridge 18 points downward in the direction of the emitted light. In some embodiments a lens panel 50 as shown (viewed edgewise) in the dashed lines of FIG. 3 may be attached to the output or base of the luminaire. The lens panel 50, which may preferably be formed of tempered glass, and may be transparent or translucent, clear or tinted to adjust the light intensity or spectral balance for specific applications. As synthetic materials that tolerate heat from the light emitters become available, they may suitably be used. Further, it may be possible to configure the lens panel 50 in a variety of shapes or structures. In one example, a grating formed of sheet metal may be appropriate for certain applications.

FIG. 4 illustrates an end view of the main reflector panel 20 of FIG. 3. In this view the overall width of the panel 20 is approximately 12 inches, and again, the angle shown is approximate. An important feature of the luminaire 10 of the present invention is the intermediate ridge reflector 18 and its apex 36 that is disposed midway between the positions of the first and second light emitting elements 14, 16 (See also FIG. 1). As shown in FIG. 2, the light emitting elements 14, 16 are each mounted in the approximate center of the respective sides of the main reflector panel 20 at the locations 32. Each of the sides of the ridge reflector 18, like the end sections of the main reflecting panel 20 and the first and second side panels 22, 24, provides a reflecting surface to divert the light emitted laterally from the first and second light emitting elements 14, 16 in a downward direction to provide a substantially uniform pattern of light from the luminaire at a suggested target area. It will be appreciated that the light emission patterns from the two sides of the luminaire substantially overlap. This overlap is intentional because it provides a way to mixing the spectra and/or intensities of the first and second light emitting elements, which may generally be selected to have different output characteristics to provide a particular color temperature, intensity, and distribution of light at wavelengths selected for the particular application. However, in some embodiments it may be an advantage to select light emitting elements having similar characteristics.

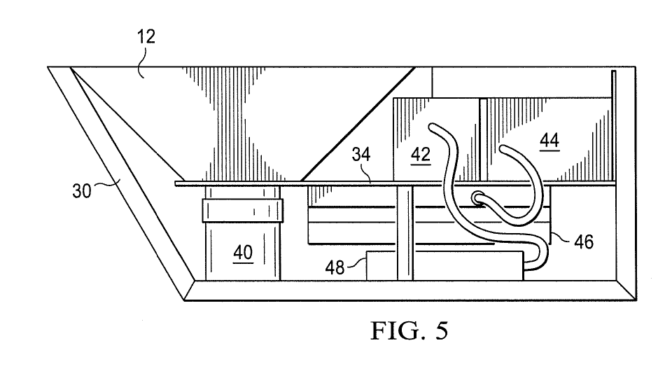

FIG. 5 illustrates a side view of the luminaire 10 with its side panel removed to show internal features of the illustrated embodiment. The reflector 12 is supported within the housing or canopy 30 by conventional means familiar in the mechanical arts. The structure may preferably include a subchassis 34 that supports the reflector 12 and the plasma lamp assemblies 14, 16. The circuitry for operating the plasma lamp assemblies 14, 16 includes their respective lamp modules or sockets 40 (only one module 40 is visible in this side view figure) and the respective RF driver units 42, 44, which are powered by power supply 46. A fan 48 to cool the RF drivers 42, 44 and the power supply 46, may be mounted in the surface of the housing or canopy 30 as indicated by reference number 48. The RF drivers 42, 44 and the power supply 46 may be equipped with heat sinks (not shown), and the housing or canopy 30 may include ventilation openings (not shown) placed at appropriate locations to permit air to be admitted and exhausted for cooling.

While the invention has been shown in only one of its forms, it is not thus limited but is susceptible to various changes and modifications without departing from the spirit thereof. In the example illustrated and described herein, the reflector unit is configured with flat reflecting surfaces that form a rectangular shell around each small, high efficiency light source that have selected spectral power distribution, intensity, and color temperature characteristics. As persons of skill in the art recognize, such reflectors are an approximation to an ideal reflector; that is, some efficiency is sacrificed to provide a rectangular light pattern on the target area that while being somewhat diffuse, is also confined to the area of interest. Such persons will also recognize that shapes, dimensions, and angles may be varied to suit particular objectives in the pattern of the light field produced by a luminaire constructed according to the principles described and illustrated herein.

In other applications, reflectors having a parabolic or other geometric cross-section with the light source positioned at its focus point, may provide a light pattern better suited to the area or item to be illuminated. For example, the compound reflector panels may alternatively be formed as curved, right conic section surfaces of revolution having their apex portions similarly removed along an upper plane oriented substantially parallel with the base of the figure. In addition to a triangular surface of revolution, a parabolic or hyperbolic surface of revolution or even a hemispherical surface may also be suitable for some applications of this embodiment. In the case of the parabolic and hyperbolic forms, the light emitter may typically be mounted at the apex; thus no upper plane need be created. Upon merging two such reflectors their surfaces may also intersect along a predetermined common or mutual boundary to provide a substantially V-shaped reflecting element disposed centrally between the light emitters as described above. In other embodiment employing a parabolic form, the V-shaped ridge may not be required.

In an alternate embodiment, the compound reflector may be formed as a portion of an ellipsoid—an elliptical figure rotated about its longitudinal axis through an angle of 180 (or lesser angle) to form a reflector having an elliptical shape in plan view and side view, with the first and second point source light emitters located at the foci of the plan view of the ellipse.

Further, the description herein provided one method of constructing the reflector surface, by assembling blank panels—as depicted in FIGS. 2, 3, and 4—using rivets or spot welds to attach the panels together. Alternatively, the reflector may be formed as one piece in a stamping or other forming operation using appropriate tooling and machinery to provide a single panel having the appropriate compound shape. Materials for the reflector surfaces may be varied to suit the particular application as to size, method of manufacture, etc.

What is claimed is:

1. An illumination apparatus, comprising:
a compound reflector panel formed of first and second reflecting portions for directing light energy from at least two spaced-apart, point source light emitters into a composite light emission pattern having substantially uniform spatial and spectral illumination of a predetermined target area; and
first and second solid state plasma light emitters, having defined spectral characteristics and mounted in spaced-apart relationship in the respective first and second reflecting portions of the compound reflector panel.

2. The apparatus of claim 1, wherein the compound reflector panel comprises:
an array of intersecting surfaces disposed around each light source, the panels arranged to reflect emission from each light emitter into a merged pattern of illumination at the predetermined target area.

3. The apparatus of claim 2, wherein the array of intersecting surfaces comprises:
an array of flat reflecting surfaces formed by respective frustums of first and second right, rectangular or triangular pyramid-shaped shells partially merged and joined together along a common boundary.

4. The apparatus of claim 3, wherein the common boundary defines the apex of a substantially V-shaped, downward-pointing ridge disposed midway between the first and second light emitters and aligned at a right angle to a centerline between the first and second light emitting sources.

5. The apparatus of claim 4, wherein the V-shaped ridge defines a partial reflecting barrier to a proximate portion of light rays emitted laterally from each first and second light emitter.

6. The apparatus of claim 1, wherein the predetermined target area is defined by a plane of illumination spaced near the illumination apparatus.

7. The apparatus of claim 1, wherein the first and second solid state plasma light emitters comprise:
emitters approximating point sources of light and having broadband emission characteristics within at least a portion of the visible spectrum.

8. The apparatus of claim 1, wherein the compound reflective panel includes a reflective surface for each light emitter joined at a mutual boundary thereby forming a single compound surface.

9. The apparatus of claim 1, wherein the compound reflective panel includes at least one receptacle for a light emitter disposed within each first and second defined portion of the compound reflector panel.

10. The apparatus of claim 1, comprising:
a housing formed as a canopy for enclosing a backside of the compound reflector panel and circuitry for operating the first and second light emitters.

11. The apparatus of claim 1, wherein the first and second solid state plasma light emitters comprise:
emitters approximating point sources of light, each having dissimilar defined spectral characteristics.

12. An illumination apparatus, comprising:
a compound reflector panel, formed of first and second defined reflecting surfaces and joined along a common boundary, for directing light energy from at least two spaced-apart, point source light emitters into a combined emission pattern having substantially uniform spatial and spectral illumination at a predetermined target area; and
first and second solid state light emitting diodes, each approximating point sources of light having defined emission characteristics within a substantial portion of the visible spectrum and mounted in the respective first and second defined reflecting surfaces of the compound reflector panel.

13. The apparatus of claim 12, wherein the compound reflector panel comprises:
an array of intersecting surfaces disposed around each light source, the panels arranged to reflect emission from each light emitter into a merged pattern of illumination at the predetermined target area.

14. The apparatus of claim 13, wherein the array of intersecting surfaces comprises:
an array of flat reflecting surfaces formed by respective frustrums of first and second right, rectangular or triangular pyramid-shaped shells partially merged and joined together along a common boundary.

15. The apparatus of claim 14, wherein the common boundary defines the apex of a substantially V-shaped, downward-pointing ridge disposed midway between the first and second light emitters and aligned at a right angle to a centerline between the first and second light emitting sources.

16. The apparatus of claim 15, wherein the V-shaped ridge defines a partial reflecting barrier to a proximate portion of light rays emitted laterally from each first and second light emitter.

17. The apparatus of claim 12, wherein the predetermined target area is defined by a plane of illumination spaced near the illumination apparatus.

18. The apparatus of claim 12, wherein the first and second solid state light emitting diodes comprise:
emitters approximating point sources of light and having broadband emission characteristics within at least a portion of the visible spectrum.

19. The apparatus of claim 12, wherein the compound reflective panel includes a reflective surface for each light emitter joined at a mutual boundary thereby forming a single compound surface.

20. The apparatus of claim 12, wherein the compound reflective panel includes at least one receptacle for a light emitter disposed within each first and second defined portion of the compound reflector panel.

21. The apparatus of claim 12, comprising:
a housing formed as a canopy for enclosing a backside of the compound reflector panel and circuitry for operating the first and second light emitters.

22. The apparatus of claim 12, wherein the first and second light emitting diodes comprise:
light emitters approximating point sources of light, each having dissimilar defined spectral characteristics.

23. An illumination apparatus for indoor horticulture, comprising:
a compound reflector panel having first and second reflecting portions for directing light energy respectively from a first and a second spaced-apart, point source light emitter;
the compound reflector panel formed as an array of reflecting surfaces disposed around each first and second light emitter, the surfaces formed by respective frustrums of first and second right, rectangular or triangular pyramid-shaped shells partially merged and joined together along a common boundary which defines the apex of a substantially V-shaped, downward-pointing ridge disposed midway between the first and second light emitters, the ridge aligned substantially at a right angle to a centerline between the first and second light emitters; and
first and second solid state plasma light emitters, having dissimilar spectral characteristics and mounted in spaced-apart relationship in the respective first and second reflecting portions of the compound reflector panel;
wherein the compound reflector panel provides a merged pattern of illumination at a predetermined target area with substantially uniform spatial and spectral illumination thereof.

24. The apparatus of claim 23, wherein the V-shaped ridge defines a partial reflecting barrier to a proximate portion of light rays emitted laterally from each first and second light emitter.

25. The apparatus of claim 23, wherein the compound reflective panel includes a reflective surface for each light emitter joined at a mutual boundary thereby forming a single compound surface.

26. The apparatus of claim 23, comprising:
a housing formed as a canopy for enclosing a backside of the compound reflector panel and circuitry for operating the first and second light emitters.

27. The apparatus of claim 23, wherein the first and second light emitters comprise:
emitters approximating point sources of light and having broadband emission characteristics within at least a portion of the visible spectrum.
